(19) United States
(12) Patent Application Publication
(10) Pub. No.: US 2025/0327657 A1
(43) Pub. Date: Oct. 23, 2025

(54) OPTICAL DISPLACEMENT METER

(71) Applicant: Keyence Corporation, Osaka (JP)

(72) Inventor: Kaoru KANAYAMA, Osaka (JP)

(73) Assignee: Keyence Corporation, Osaka (JP)

(21) Appl. No.: 19/095,066

(22) Filed: Mar. 31, 2025

(30) Foreign Application Priority Data
Apr. 18, 2024 (JP) 2024-067162

(51) Int. Cl. G01B 11/02; G01S 7/48; G01S 7/481; G01S 17/48

(52) U.S. Cl. CPC G01B 11/026; G01S 7/4802; G01S 7/4814; G01S 7/4816; G01S 7/4817; G01S 17/48

(57) ABSTRACT

An optical displacement meter controls an image sensor to sequentially acquire a plurality of light reception images along with the relative movement of the workpiece, detects a peak position candidate in a V direction for each position in the U direction based on a light receiving amount distribution of the light reception image, and, for each position in the U direction, generates one or more clusters including a plurality of peak position candidates selected such that a distance between a peak position candidate of any one light reception image and a peak position candidate of another light reception image is equal to or less than a certain value, determines whether noise is included in the cluster based on an inclination of the cluster with respect to a direction of the relative movement, and generates profile data of the workpiece based on a result of the determination.

### CROSS-REFERENCE TO RELATED APPLICATIONS

The present application claims foreign priority based on Japanese Patent Application No. 2024-067162, filed Apr. 18, 2024, the contents of which are incorporated herein by reference.

### BACKGROUND OF THE INVENTION

### 1. Technical Field

The present invention relates to an optical displacement meter that detects a displacement of a measurement object by a triangulation method.

### 2. Description of the Related Art

In an optical displacement meter using a light sectioning method, a measurement object (hereinafter, referred to as a workpiece) is irradiated with band-shaped light having a linear cross section from a light projecting unit, and reflected light thereof is received by a two-dimensional light receiving element. A profile of the workpiece is measured based on a position of a peak of a light receiving amount distribution obtained by the light receiving element. Here, there is a case where the light emitted to the workpiece is multiple-reflected on a surface of the workpiece. In this case, a plurality of peaks appear in the light receiving amount distribution as the multiple-reflected light is incident on the light receiving element, and thus, it is impossible to measure an accurate profile of the workpiece.

A similar problem also occurs in a case where light (disturbance light) from a portion other than the light projecting unit is incident on the light receiving element or in a case where light reflected from a portion other than a measurement target portion of the workpiece is incident on the light receiving element.

Noise due to the multiple reflection is generated and observed in units of light reception images. An optical displacement meter disclosed in JP 2020-027053 A distinguishes between a true peak position and noise due to multiple reflection based on a positional relationship between peak candidates in a U direction corresponding to an X direction (direction in which slit light extends) using one light reception image itself.

The present inventor and others have conducted various studies on the noise due to the multiple reflection, and have found that a true peak position can be distinguished from noise due to multiple reflection based on a positional relationship between peak candidates in a scan direction in a case where a three-dimensional image is acquired by acquiring a plurality of light reception images and a plurality of profiles in the scan direction by a relative movement between an optical displacement meter and a workpiece.

### SUMMARY OF THE INVENTION

An object of the present invention is to provide a new technique for suppressing noise due to multiple reflection when a shape of a workpiece is measured by irradiating the workpiece relatively moving in a direction intersecting an X direction with slit light extending in the X direction.

According to one embodiment of the present invention, an optical displacement meter includes: a light projection unit that irradiates a workpiece performing a relative movement in a direction intersecting an X direction with slit light extending in the X direction; an image sensor that includes a plurality of pixels, receives reflected light reflected from the workpiece by the plurality of pixels, and outputs a light reception image indicating a light receiving amount distribution, the plurality of pixels being two-dimensionally arranged in a U direction corresponding to the X direction and a V direction orthogonal to the U direction; and a control unit that generates profile data of the workpiece based on the light reception image and measures a shape of the workpiece based on the profile data The control unit controls the image sensor to sequentially acquire a plurality of the light reception images along with the relative movement, detects a peak position candidate in the V direction for each of positions in the U direction based on the light receiving amount distribution of the light reception image for each of the light reception images, and, for each of the positions in the U direction, generates one or more clusters including a plurality of peak position candidates selected in such a manner that a distance between a peak position candidate of any one of the light reception images and a peak position candidate of another one of the light reception images is equal to or less than a certain value, determines whether noise is included in the cluster based on an inclination of the cluster with respect to a direction of the relative movement, and generates the profile data based on a result of the determination.

According to another embodiment of the present invention, an optical displacement meter includes: a light projection unit that irradiates a workpiece performing a relative movement in a direction intersecting an X direction with slit light extending in the X direction; an image sensor that includes a plurality of pixels, receives reflected light reflected from the workpiece by the plurality of pixels, and outputs a light reception image indicating a light receiving amount distribution, the plurality of pixels being two-dimensionally arranged in a U direction corresponding to the X direction and a V direction orthogonal to the U direction; and a control unit that generates profile data of the workpiece based on the light reception image and measures a shape of the workpiece based on the profile data The control unit controls the image sensor to sequentially acquire a plurality of the light reception images along with the relative movement, detects a peak position candidate in the V direction for each of positions in the U direction based on the light receiving amount distribution of the light reception image for each of the light reception images, converts UV coordinate information including each of the positions in the U direction and the peak position candidate in the V direction at each of the positions in the U direction and information regarding the relative movement into XYZ coordinate information including a peak position candidates in a Z direction corresponding to each of XY coordinates based on a predetermined coordinate conversion condition, and, for each position in the X direction of the XYZ coordinate information, generates one or more clusters including a plurality of peak position candidates selected in such a manner that a distance between a peak position candidate at any one position in the Y direction and a peak position candidate at another position in the Y direction is equal to or less than a certain value, determines whether noise is included in the cluster based on an inclination of the cluster with respect to the Y direction, and generates the profile data based on a result of the determination.

Note that other features, elements, steps, advantages, and characteristics will be more apparent from the following detailed description of preferred embodiments and the accompanying drawings.

The optical displacement meter according to the present invention can provide the new technique for suppressing the noise due to multiple reflection when the shape of the workpiece is measured by irradiating the workpiece relatively moving in the direction intersecting the X direction with the slit light extending in the X direction.

### BRIEF DESCRIPTION OF THE DRAWINGS

FIG. 1 is a diagram illustrating an optical displacement measurement system according to a first embodiment;

FIG. 2 is a diagram illustrating a measurement range of a rotary optical displacement meter;

FIG. 3 is a view illustrating the optical displacement meter including a reflecting member;

FIG. 4 is a view for describing a method of detecting a peak position;

FIG. 5 is a functional block diagram of the optical displacement meter;

FIG. 6A is a schematic view illustrating a true height of a workpiece and a height that may be erroneously recognized;

FIG. 6B is a schematic view illustrating the true height of the workpiece and the height that may be erroneously recognized;

FIG. 6C is a schematic view illustrating the true height of the workpiece and the height that may be erroneously recognized;

FIG. 7 is profile data obtained by collecting heights of the workpiece at respective positions in the Y direction;

FIG. 8 is a view illustrating a processing flow of a measurement operation of the optical displacement measurement system;

FIG. 9A is a view illustrating two-dimensional data of a peak candidate group;

FIG. 9B is a view illustrating two-dimensional data of the peak candidate group divided into clusters;

FIG. 9C is a view illustrating corrected two-dimensional data of the peak candidate group divided into the clusters;

FIG. 9D is a view illustrating corrected two-dimensional data of the peak candidate group divided into the clusters;

FIG. 9E is a view illustrating two clusters having different inclinations;

FIG. 9F is a view illustrating two clusters having different inclinations;

FIG. 9G is a diagram illustrating two clusters having different inclinations;

FIG. 10 is a view illustrating another processing flow of the measurement operation of the optical displacement measurement system;

FIG. 11 is a view illustrating an optical displacement measurement system according to a second embodiment;

FIG. 12 is a view illustrating the principle of triangulation;

FIG. 13 is a view for describing a method of detecting a peak position;

FIG. 14 is a functional block diagram of an optical displacement meter;

FIG. 15 is a schematic view illustrating a true height of a workpiece and a height that may be erroneously recognized;

FIG. 16 is profile data obtained by collecting heights of the workpiece at respective positions in the Y direction; and

FIG. 17 is a diagram illustrating a modified example of the optical displacement meter.

### DETAILED DESCRIPTION

Hereinafter, embodiments of the present invention will be described in detail with reference to the drawings. Note that the following preferred embodiments are described merely as examples in essence, and there is no intention to limit the invention, its application, or its use.

### First Embodiment

### <Optical Displacement Measurement System>

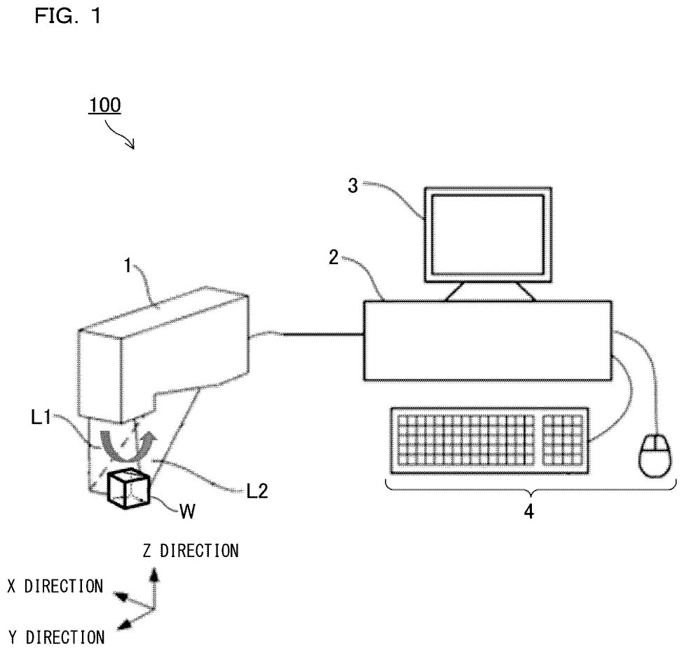

FIG. 1 is a diagram illustrating a schematic configuration example of an optical displacement measurement system according to a first embodiment. An optical displacement measurement system 100 illustrated in FIG. 1 includes an optical displacement meter 1, a control device 2, a display device 3, and an input device 4.

In the present embodiment, an X direction corresponds to a width direction of slit light L1 output from the optical displacement meter 1, a Z direction corresponds to a height direction of a workpiece W, and a Y direction corresponds to a direction in which the slit light L1 moves by rotation of a light projecting unit (not illustrated in FIG. 1). A XZ plane to be described later is a plane extending in the X direction and the Z direction. Note that the optical displacement meter 1 scans the slit light L1 by rotating a light projecting/receiving module 20, and thus, a scanning direction of the slit light L1 is a direction orthogonal to the X direction on a YZ plane including the Y direction. Note that “rotation” in the present specification means swinging motion that reciprocates with a rotation axis as the center.

The optical displacement measurement system 100 is a system that measures a profile and a three-dimensional shape of the workpiece W. The profile of the workpiece W is data indicating an outer edge of a cut surface of the workpiece W by the slit light L1. When the slit light is emitted in parallel to the XZ plane, the profile of the workpiece W is data indicating an outer edge of a cut surface parallel to the XZ plane, and thus, is also referred to as a two-dimensional profile of a XZ cross-section of the workpiece W.

For example, the profile is an aggregate of (xi, zi) (i is an index). “xi” indicates a position in the X direction. “zi” indicates a height in the Z direction. Note that the three-dimensional shape is an aggregate of (xi, yi, zi). “yi” indicates a position in the Y direction.

The optical displacement meter 1 operates in accordance with an instruction from the control device 2. The optical displacement meter 1 outputs the slit light L1 extending in the X direction and receives reflected light L2 from the workpiece W. Then, the optical displacement meter 1 calculates a profile of the workpiece W based on a light reception result. The optical displacement meter 1 captures images at regular intervals to generate profiles of the workpiece W having different values of yi. In addition, the optical displacement meter 1 generates three-dimensional shape data of the workpiece W from the profiles of the workpiece W having different values of yi.

The control device 2 outputs an instruction based on a user input received by the input device 4 to the optical displacement meter 1, and receives a measurement result of the workpiece W from the optical displacement meter 1. In addition, the control device 2 outputs a display signal to the display device 3. The control device 2 is, for example, a personal computer, a programmable logic control unit, or the like.

The display device 3 displays, for example, the measurement result of the workpiece W, a user interface (UI) for setting the optical displacement meter 1, and the like based on the display signal from the control device 2.

The input device 4 receives the user input with respect to the optical displacement measurement system 100. In FIG. 1, a keyboard and a mouse are illustrated as the input device 4. However, the input device 4 is not limited to the keyboard and the mouse. For example, the input device 4 may be a touch panel disposed on a display screen of the display device 3.

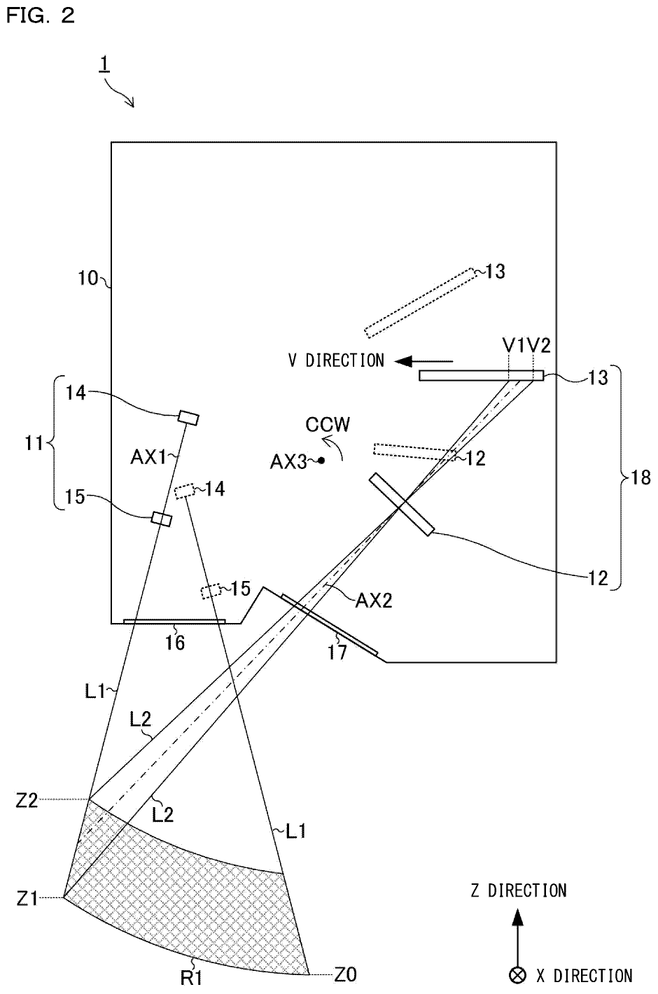

FIG. 2 is a diagram illustrating a measurement range of the rotary optical displacement meter 1. A light projecting unit 11, a light receiving lens 12, and an imaging unit 13 are stored in a housing 10 of the optical displacement meter 1. The light projecting unit 11 includes a light source 14 and a light projecting lens 15. For example, the light source 14 may be a laser light emitter, and the light projecting lens 15 may include a plurality of lenses including a cylindrical lens.

Light output from the light source 14 passes through the light projecting lens 15 and is converted into the slit light L1. The housing 10 is provided with a light projecting window 16 having a light transmitting property that allows the slit light L1 to pass therethrough. Similarly, the housing 10 is provided with a light receiving window 17 having a light transmitting property that allows the reflected light L2 to pass therethrough. The light projecting window 16 and the light receiving window 17 are separate bodies (separate components). Since the light projecting window 16 and the light receiving window 17 are separate bodies, each of the light projecting window 16 and the light receiving window 17 is a flat plate-shaped component, and the light projecting window 16 and the light receiving window 17 can be easily manufactured. However, the light projecting window 16 and the light receiving window 17 may be integrated (one component).

The light receiving lens 12 is a lens configured to collect the reflected light L2 and form an image on a light receiving surface of the imaging unit 13. The light receiving lens 12 may include only one lens or may include a plurality of lenses. In addition, the light receiving lens 12 may also include an optical component (for example, an optical filter or the like) other than the lens. The imaging unit 13 is an image sensor including a plurality of photoelectric conversion elements arranged two-dimensionally. The imaging unit 13 receives the light collected by the light receiving lens.

As illustrated in FIG. 2, an optical axis AX2 of the light receiving lens 12 is inclined with respect to a light projection axis AX1 of the light projecting unit 11. The light projection axis AX1 of the light projecting unit 11 coincides with an optical axis of the light source 14. As a result, the reflected light L2 from a height Z1 forms an image at a position V1 in a V direction of the light receiving surface of the imaging unit 13, and the reflected light L2 from a height Z2 forms an image at a position V2 in the V direction of the light receiving surface of the imaging unit 13. That is, the V direction of the light receiving surface of the imaging unit 13 corresponds to the Z direction of the workpiece W. Although a U direction of the light receiving surface of the imaging unit 13 is not illustrated, the U direction corresponds to the X direction of the workpiece W. That is, a vertical direction of a light reception image indicating a light receiving amount distribution output by the imaging unit 13 is the V direction, and a horizontal direction thereof is the U direction.

The light projecting unit 11, the light receiving lens 12, and the imaging unit 13 are rotatable about a rotation axis AX3 along the X direction. Relative positions of the light projecting unit 11, the light receiving lens 12, and the imaging unit 13 are fixed. For example, the light projecting unit 11, the light receiving lens, and the imaging unit 13 are disposed and fixed on a support member (not illustrated) in a state in which relative positions thereof are fixed. In FIG. 2, a state of the light projecting unit 11, the light receiving lens 12, and the imaging unit 13 before rotation in a counterclockwise direction CCW is illustrated by a solid line, and a state thereof after rotation in the counterclockwise direction CCW is illustrated by a broken line.

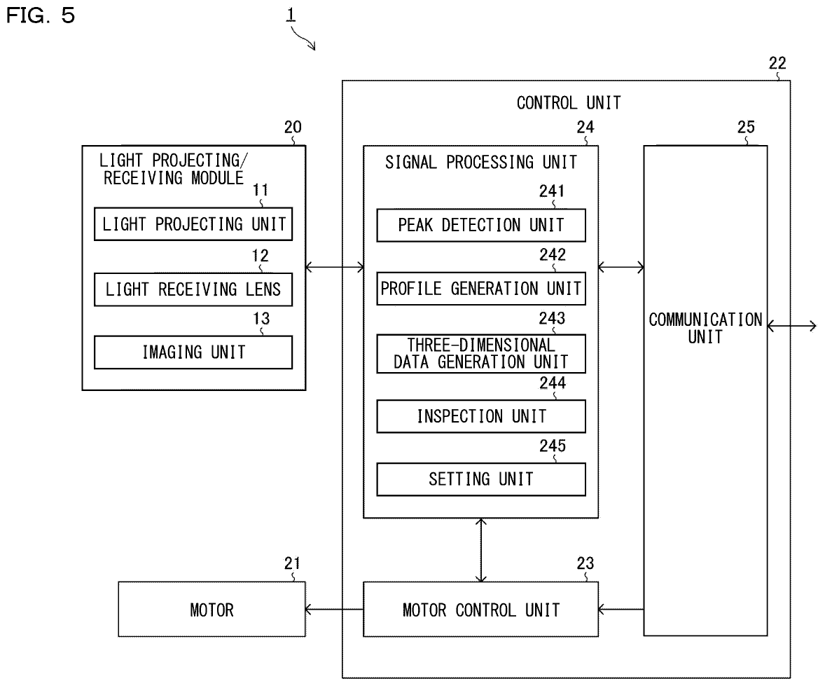

When a rotation range of the motor 21 (see FIG. 5 to be described later) is limited, rotation ranges of the light projecting unit 11, the light receiving lens 12, and the imaging unit 13 are also limited. The rotation range of the motor 21 may be limited by, for example, the control of the motor 21 or by a stopper that physically stops the motion of the light projecting/receiving module 20 (see FIG. 5 to be described later).

At one end of the rotation range of the motor 21, the light receiving window 17 and an end on the workpiece W side of the light receiving unit 18 including the light receiving lens 12 and the imaging unit 13 are closest to each other while being separated from each other, and an inner wall of the housing 10 and the light projecting unit 11 are separated from each other. At the other end of the rotation range of the motor 21, the light projecting window 16 and the end on the workpiece W side of the light projecting unit 11 are closest to each other while being separated from each other, and the inner wall of the housing 10 and the light receiving unit 18 are separated from each other. As a result, the housing 10 can be reduced in size while avoiding contact between the light receiving window 17 and the light receiving unit 18 and contact between the light projecting window 16 and the light projecting unit 11.

The light projecting unit 11, the light receiving lens 12, and the imaging unit 13 are rotatable about a rotation axis AX3 along the X direction in a state of satisfying the Scheimpflug relationship in which the light receiving surface of the imaging unit 13 is inclined with respect to the optical axis of the light receiving lens 12. As a result, each cross-section through which the light projection axis AX1 passes is in focus in a region R1 illustrated by hatching in FIG. 2. That is, the optical displacement meter 1 can generate the profile of the workpiece W in focus even if the height of the workpiece W changes. Therefore, it is sufficient to use the region R1 as a measurement range of the slit light L1. That is, it is sufficient to form the measurement range of the slit light L1 using a range in which the Scheimpflug relationship is established for each rotation angle of the motor 21 (see FIG. 5 to be described later).

Note that the positional relationship among the light projecting unit 11, the light receiving lens 12, and the imaging unit 13 may be opposite to the positional relationship illustrated in FIG. 2.

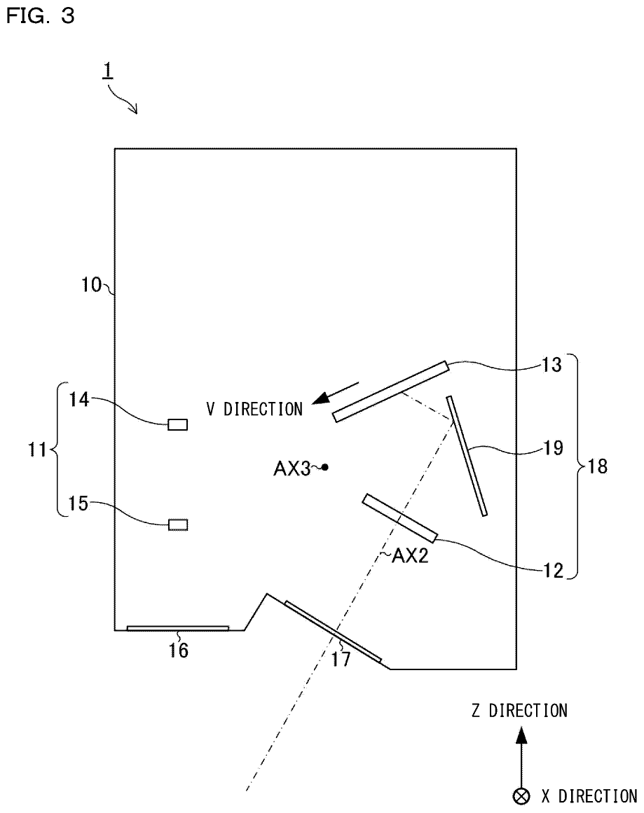

In addition, the optical displacement meter 1 may further include a reflecting member 19 as illustrated in FIG. 3. In a case where the optical displacement meter 1 includes the reflecting member 19, a light receiving unit 18 includes the light receiving lens 12, the imaging unit 13, and the reflecting member 19. The reflecting member 19 is provided on an optical path between the light receiving window 17 and the imaging unit 13, and turns the reflected light L2 and the optical axis AX2 of the light receiving lens 12 toward the light projecting unit 11. As a result, it is possible to form a compact light projecting/receiving module that integrally holds the light projecting unit 11, the light receiving lens 12, the imaging unit 13, and the reflecting member 19 in the YZ plane extending in the Y direction and the Z direction. Therefore, it is possible to reduce a moment of inertia about the rotation axis AX3 of the light projecting/receiving module integrally holding the light projecting unit 11, the light receiving lens 12, the imaging unit 13, and the reflecting member 19.

In FIG. 3, the reflecting member 19 is provided on the optical path between the light receiving lens 12 and the imaging unit 13, but may be provided on an optical path between the light receiving window 17 and the light receiving lens 12.

In a case where the reflecting member 19 is provided on the optical path between the light receiving lens 12 and the imaging unit 13, the reflecting member 19 reflects the light collected by the light receiving lens 12, and thus, the area of a reflection surface of the reflecting member 19 can be reduced. In a case where the reflecting member 19 is provided on the optical path between the light receiving window 17 and the light receiving lens 12, the heavy light receiving lens 12 can be disposed close to the rotation axis AX3, and thus, the effect of reducing the moment of inertia increases.

### <Position (Calculation of Height)>

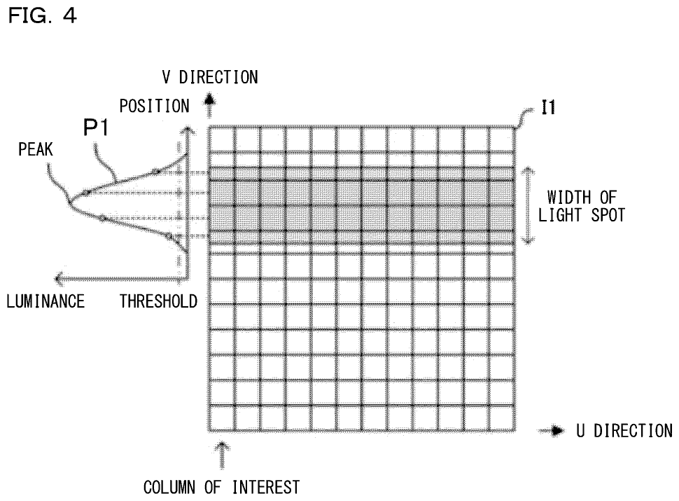

FIG. 4 is a view for describing a method of calculating a height forming a profile from an image I1 that is a light reception result output by the imaging unit 13. The slit light L1 has a certain width in the Y direction. Therefore, a width of a light spot formed by the reflected light L2 on the light receiving surface of the imaging unit 13 is also a width that spans the plurality of photoelectric conversion elements.

Therefore, the optical displacement meter 1 obtains an approximate curve P1 indicating a change in a luminance value from luminance values of pixels, and calculates a position in the V direction at which a peak value is obtained in the approximate curve P1. In FIG. 4, the leftmost column is a column of interest, and the distribution (approximate curve P1) of luminance values of the column of interest is illustrated. The approximate curve P1 is obtained by curve fitting or the like of a plurality of sample values. A sample value below a detection threshold is not considered. The position in the V direction at which the peak value is obtained indicates a height of the workpiece W. The optical displacement meter 1 obtains the approximate curve P1 at each position (each pixel column) in the U direction, and calculates the position (height) in the V direction at which the peak value is obtained from the approximate curve P1. This calculation processing is executed at each position in the U direction, thereby obtaining one profile. Such calculation processing may be referred to as subpixel processing.

Note that, for example, a coordinate conversion condition (for example, a coordinate conversion table) indicating a correspondence relationship among UV coordinates, a rotation angle θ, and local coordinates (X, Y, Z) and expressed by (U, V, θ)=(X, Y, Z) is generated by calibration before shipment, and is stored in a storage unit (not illustrated) of the optical displacement meter 1, and thus, the optical displacement meter 1 can convert a profile in a UV coordinate system into that in an XYZ coordinate system based on the rotation angle θ by simple calculation. Note that, in the coordinate conversion, equal interval correction in the X direction and the Y direction may be executed such that positions in the X direction and the Y direction are plotted at equal intervals, and a Z coordinate corresponding to the corrected (X, Y) may be obtained by linear interpolation or the like and output as a measurement result. Image processing to be performed on the measurement result is often based on data sampled at equal intervals in the X direction and the Y direction, and thus the subsequent image processing is facilitated by the equal interval correction.

### <Functional Blocks>

FIG. 5 is a functional block diagram of the optical displacement meter 1. The optical displacement meter 1 includes the light projecting/receiving module 20, a motor 21, and a control unit 22.

The light projecting/receiving module 20 holds the light projecting unit 11, the light receiving lens 12, and the imaging unit 13 in an integrated manner. In addition, in a case where the optical displacement meter 1 includes the reflecting member 19, the light projecting/receiving module 20 holds the light projecting unit 11, the light receiving lens 12, the imaging unit 13, and the reflecting member 19 (not illustrated in FIG. 5) in an integrated manner.

The motor 21 rotates the light projecting unit 11, the light receiving lens 12, and the imaging unit 13. More specifically, the motor 21 rotates the light projecting/receiving module 20. The motor 21 may rotate the light projecting/receiving module 20 by a direct drive system in which an intermediate mechanism such as a speed reducer is not disposed between the motor 21 and the light projecting/receiving module 20, or may rotate the light projecting/receiving module 20 via the intermediate mechanism such as the speed reducer.

The control unit 22 includes a motor control unit 23, a signal processing unit 24, and a communication unit 25. The control unit 22 controls the motor 21 to rotate the light projecting unit 11, the light receiving lens 12, and the imaging unit 13 in the state of satisfying the Scheimpflug relationship, and scans the slit light L1 in a direction intersecting the X direction. More specifically, the motor control unit 23 controls the motor 21 to rotate the light projecting unit 11, the light receiving lens 12, and the imaging unit 13 in the state of satisfying the Scheimpflug relationship, and the signal processing unit 24 controls the light projecting unit 11 to emit the slit light L1 from the light projecting unit 11.

The signal processing unit 24 includes a peak detection unit 241, a profile generation unit 242, a three-dimensional data generation unit 243, an inspection unit 244, and a setting unit 245.

The peak detection unit 241 detects positions (peak positions) in the V direction having peaks of luminance values based on light reception results output from the imaging unit 13. The profile generation unit 242 generates one piece of profile data by collecting heights (zi) of the workpieces W at the respective positions (xi) in the X direction obtained by the peak detection unit 241. The three-dimensional data generation unit 243 generates three-dimensional shape data of the workpiece W from profiles of the workpieces W having different values of yi and generated by the profile generation unit 242.

The inspection unit 244 inspects the workpiece W based on the three-dimensional shape data of the workpiece W generated by the three-dimensional data generation unit 243. The inspection unit 244 performs predetermined measurement on the three-dimensional shape data of the workpiece W, and inspects the workpiece W based on a result of the measurement. For example, the inspection unit 244 measures a length, an angle, and the like of a predetermined portion of the workpiece W. Then, the inspection unit 244 determines whether the workpiece W is a non-defective product based on these measurement results, preset thresholds, and the like.

When the input device 4 illustrated in FIG. 1 is operated by the user, the setting unit 245 is a portion that detects the operation and receives various settings and the like related to the control unit 22. For example, the setting unit 245 sets an inspection parameter to be used by the inspection unit 244. In addition, for example, the setting unit 245 sets an imaging parameter that is an imaging condition in the imaging unit 13.

Note that at least some of the peak detection unit 241, the profile generation unit 242, the three-dimensional data generation unit 243, the inspection unit 244, and the setting unit 245 may be provided at a place separated from a main body of the optical displacement meter 1 (for example, inside the control device 2 illustrated in FIG. 1). In this case, the optical displacement meter 1 has a separate structure including the main body of the optical displacement meter 1 and a separate portion of the optical displacement meter 1.

The communication unit 25 performs wired or wireless communication with the control device 2. For example, the communication unit 25 receives an instruction from the control device 2 and transmits the instruction to the control unit 22. In addition, the communication unit 25 transmits, for example, the profile data and the three-dimensional shape data of the workpiece W generated by the signal processing unit 24 and an inspection result of the workpiece W determined by the inspection unit 244 to the control device 2.

### <Countermeasure Against Stray Light>

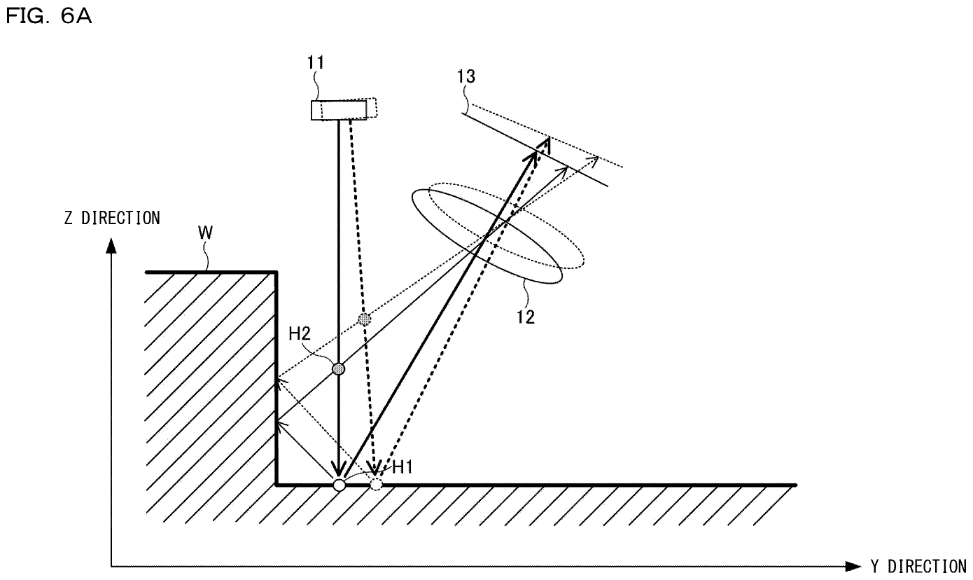

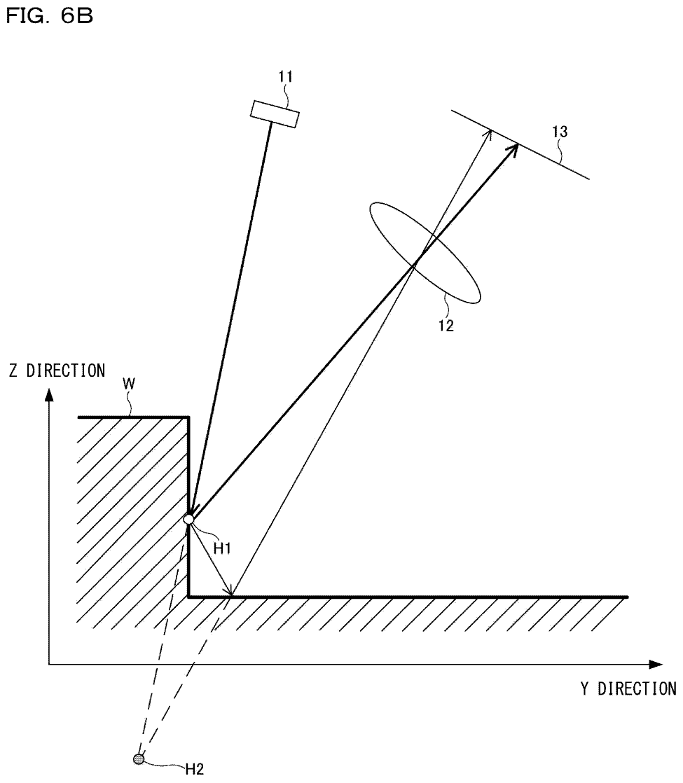

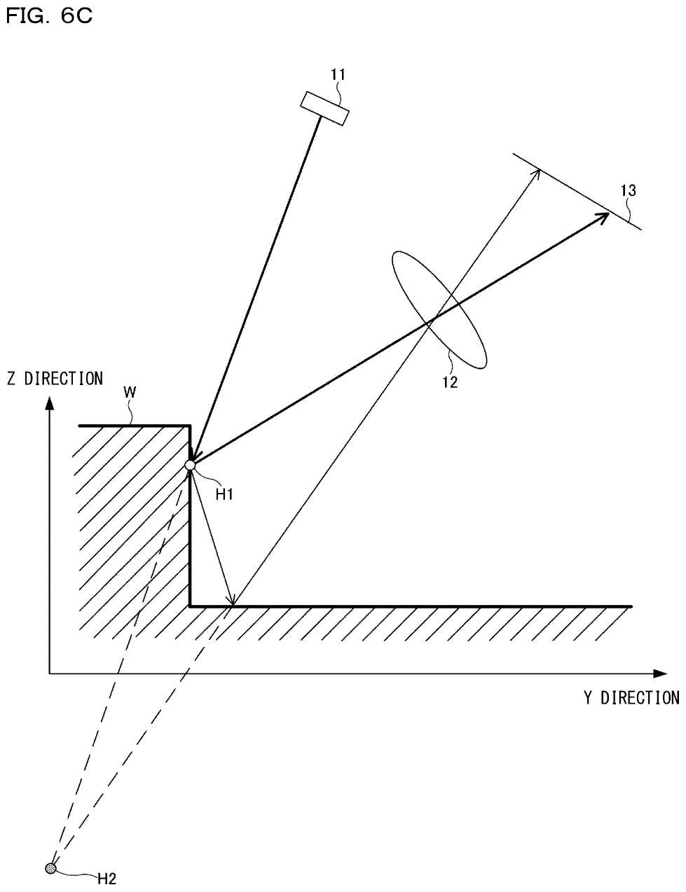

FIGS. 6A to 6C are schematic views illustrating a true height of the workpiece W and a height that may be erroneously recognized. FIG. 6A illustrates a state in which a horizontal plane extending in the Y direction of the workpiece W is measured, and measurement light reflected from the horizontal plane is not only directly incident on the imaging unit 13 but also further reflected from a vertical plane extending in the Z direction of the workpiece W and then incident on the imaging unit 13. In FIG. 6A, the light projecting unit 11, the light receiving lens 12, and the imaging unit 13 at a first measurement timing of the horizontal plane extending in the Y direction of the workpiece W are illustrated by solid lines, and the light projecting unit 11, the light receiving lens 12, and the imaging unit 13 at a second measurement timing are illustrated by broken lines. FIGS. 6B and 6C illustrate a state in which the vertical plane extending in the Z direction of the workpiece W is measured, and measurement light reflected from the vertical plane is not only directly incident on the imaging unit 13 but also further reflected from the horizontal plane extending in the Y direction of the workpiece W and then incident on the imaging unit 13. FIG. 6B illustrates a first measurement timing of the vertical plane extending in the Z direction of the workpiece W, and FIG. 6C illustrates a second measurement timing of the vertical plane extending in the Z direction of the workpiece W.

A true height H1 of the workpiece W hardly changes between the first measurement timing and the second measurement timing, whereas a height H2 at which the workpiece W may be erroneously recognized due to light (stray light) multiple-reflected on the surface of the workpiece W and entering the imaging unit 13 greatly changes between the first measurement timing and the second measurement timing.

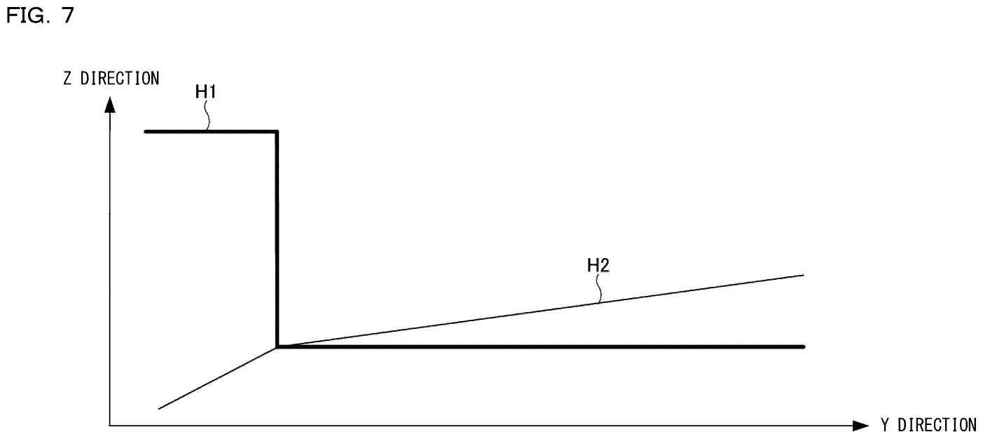

Therefore, in a case where the peak detection unit 241 does not execute a countermeasure against the stray light and the workpiece W having the shape illustrated in FIGS. 6A to 6C is measured, profile data obtained by collecting heights (zi) of the workpieces W at the respective positions (yi) in the Y direction at a certain position in the X direction is as illustrated in FIG. 7. As can be seen from FIG. 7, an inclination with respect to the Y direction of the height H2 at which the workpiece W may be erroneously recognized due to the light (stray light) multiple-reflected on the surface of the workpiece W and entering the imaging unit 13 is larger than an inclination with respect to the Y direction of the true height H1 of the workpiece W. In the present embodiment, the peak detection unit 241 executes the countermeasure against the stray light using this knowledge.

### <Processing Flow>

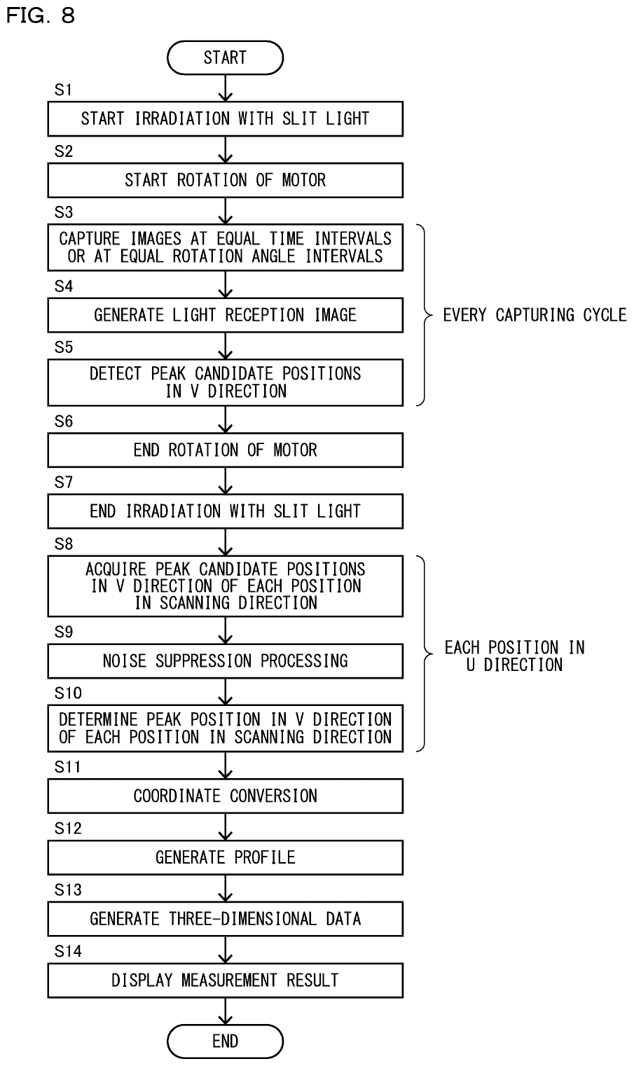

FIG. 8 is a view illustrating a processing flow of a measurement operation of the optical displacement measurement system 100. When the input device 4 receives a user input for instructing start of measurement, the processing flow of FIG. 8 is started.

First, in step S1, the light projecting unit 11 starts irradiation with the slit light L1. In subsequent step S2, the motor control unit 23 starts rotation of the motor 21. Note that the process of step S1 and the process of step S2 may be executed simultaneously. Before execution of step S1, the motor control unit 23 may rotate the motor in order to move the light projecting/receiving module 20 to a predetermined scanning start position. By the processes of steps S1 and S2, scanning of the slit light L1 is started. When the processes of steps S1 and S2 end, the flow proceeds to step S3.

The imaging unit 13 captures images at equal time intervals or at equal rotation intervals of the motor 21, for example, as an imaging cycle (step S3), and generates a light reception image in which a vertical direction is the V direction and a horizontal direction is the U direction (step S4). In the case of capturing images at equal rotation intervals, for example, position information of rotation of the motor 21 can be detected by an encoder.

In subsequent step S5, the peak detection unit 241 detects a maximum of N (N is a predetermined integer of two or more) peak candidate positions in the V direction, each of which is equal to or larger than a predetermined light receiving amount, at each position in the U direction of the light reception image. When the number of peak candidate positions in the V direction is larger than N, N peak candidate positions are detected in descending order of the light receiving amount. Note that the number of detected peak candidate positions in the V direction may be zero.

The processes of steps S3 to S5 described above are executed every capturing cycle of capturing one light reception image.

When an irradiation position of the slit light L1 reaches a scanning end position, the flow proceeds to step S6.

In step S6, the motor control unit 23 ends the rotation of the motor 21. In subsequent step S7, the light projecting unit 11 ends the irradiation with the slit light L1. Note that the process of step S6 and the process of step S7 may be executed simultaneously. By the processes of steps S6 and S7, the scanning of the slit light L1 is ended. When the scanning of the slit light L1 is ended, the flow proceeds to step S8.

The processes of steps S8 to S10 are executed for each position in the U direction.

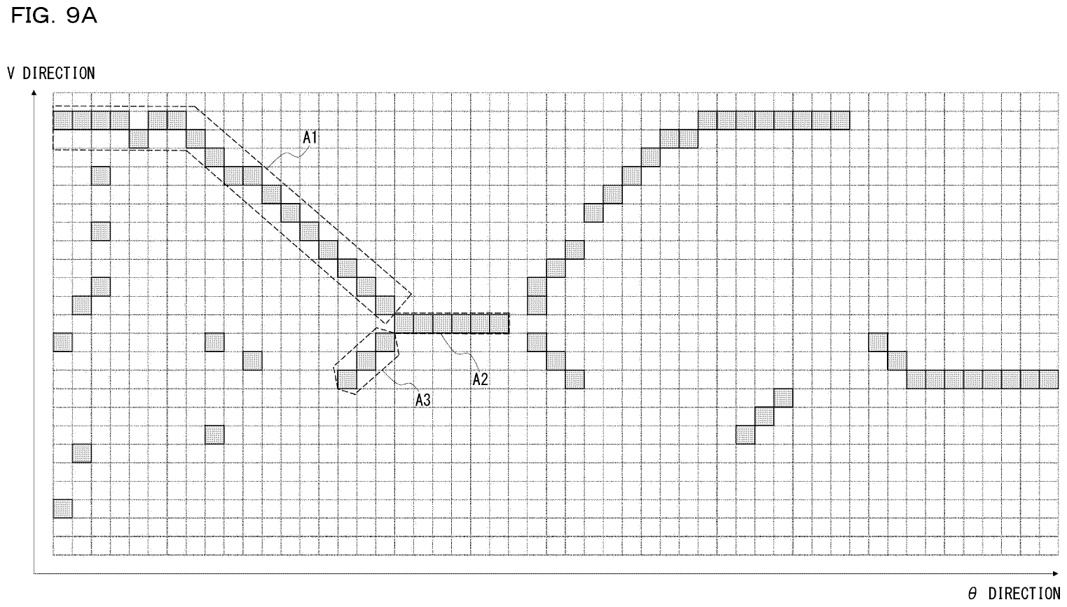

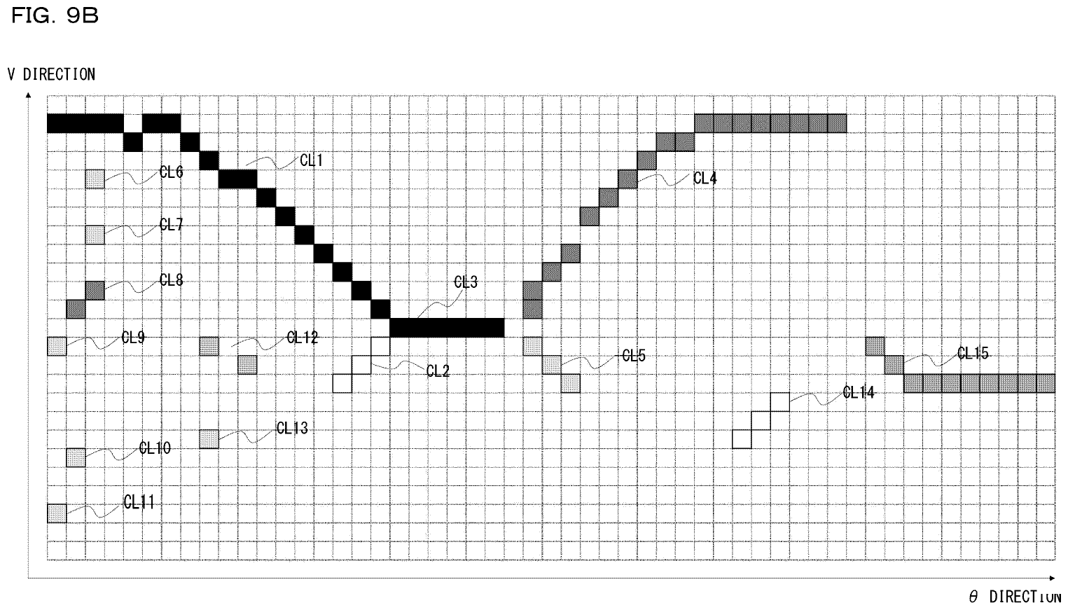

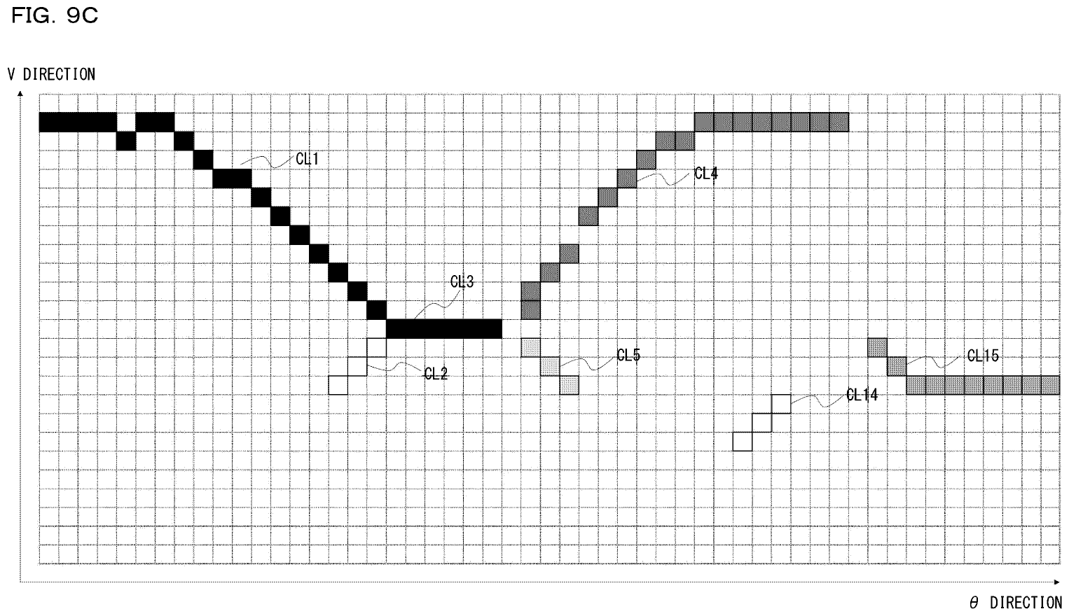

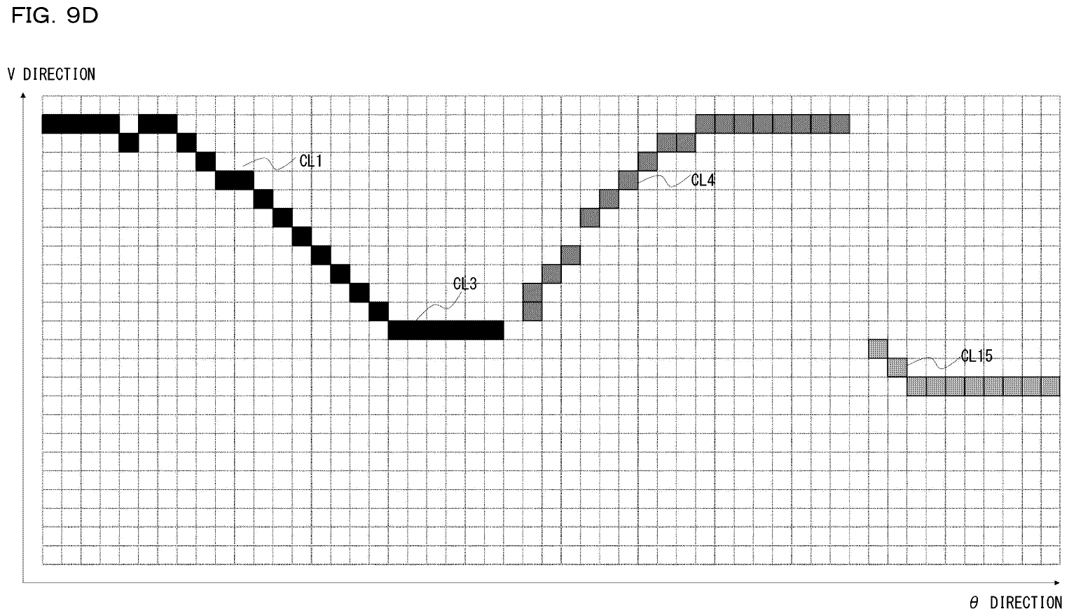

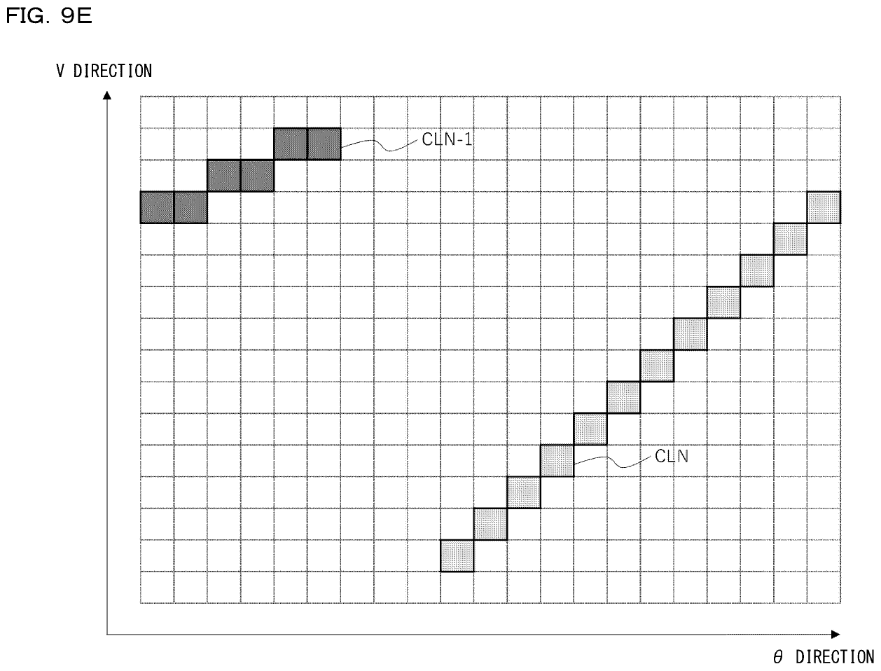

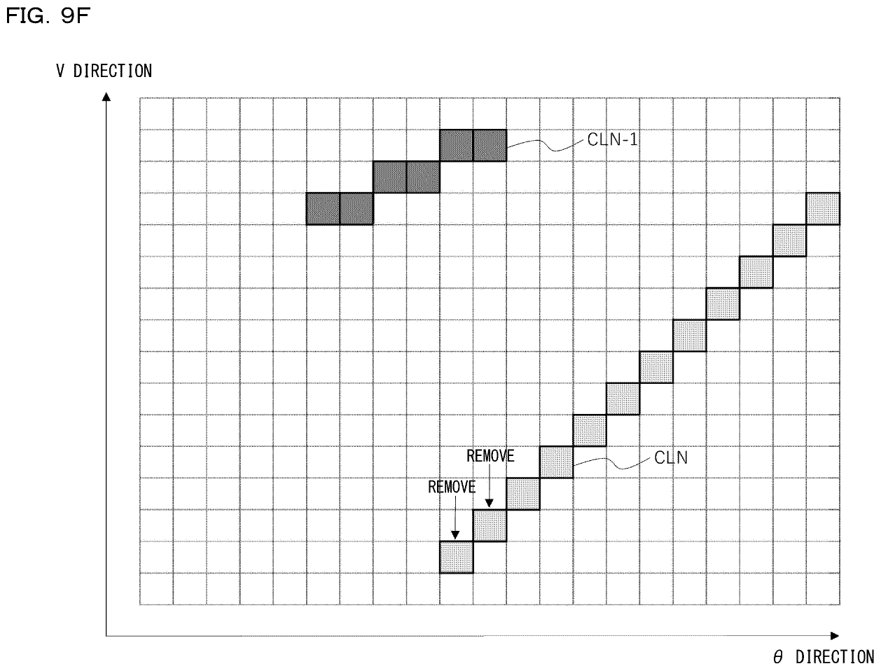

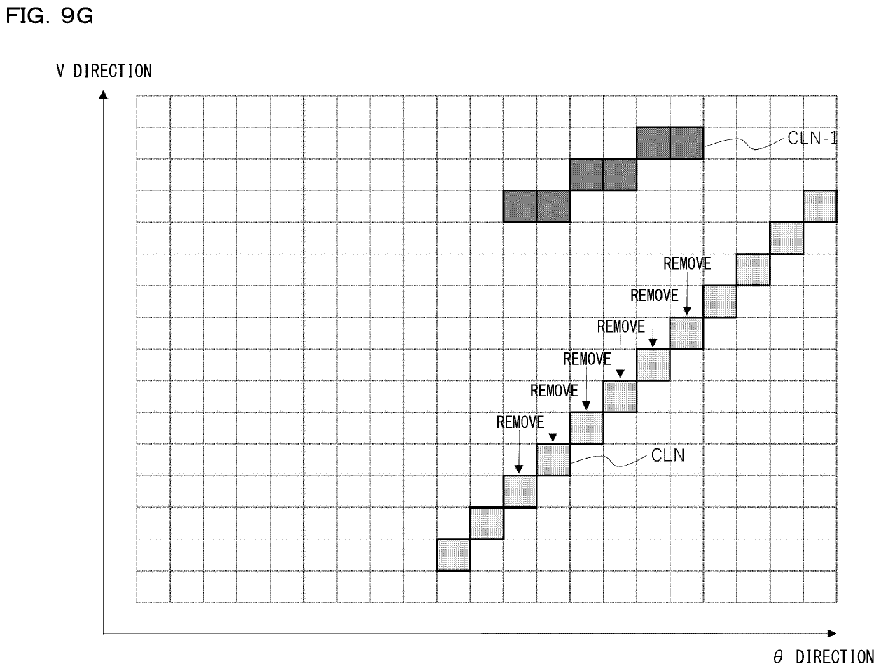

In step S8, the peak detection unit 241 plots the peak candidate positions with a θ direction as a horizontal axis and the V direction as a vertical axis at the position (Ui) in the U direction, and generates two-dimensional data of a peak candidate group as illustrated in FIG. 9A, for example. Note that a maximum number of detected peak candidate positions is set to four in the example illustrated in FIG. 9A.

In subsequent step S9, the peak detection unit 241 executes noise suppression processing. Details of the noise suppression processing will be described below.

First, in the two-dimensional data of the peak candidate group, the peak detection unit 241 configures a cluster by a plurality of peak position candidates selected such that a distance between a peak position candidate of any one light reception image and a peak position candidate of another light reception image (the light reception image having a different value in the 0 direction from that of the one light reception image) is equal to or less than a certain value. In the two-dimensional data of the peak candidate group, in a case where a peak position candidate of any one light reception image is separated from any peak position candidate of any other light reception image by a certain distance, the peak detection unit 241 configures a cluster by only one peak position candidate of the one light reception image.

Next, the peak detection unit 241 calculates an inclination of each of the clusters with respect to the θ direction by a least squares method or the like. Note that the θ direction is not strictly a straight line because it is rotation, but can be locally regarded as a straight line to calculate the inclination of each of the clusters. In a case where there are a first cluster candidate (for example, a cluster candidate A1 illustrated in FIG. 9A) and a second cluster candidate (for example, a cluster candidate A2 illustrated in FIG. 9A) having different inclinations in any one range in the θ direction, the peak detection unit 241 determines the first cluster candidate and the second cluster candidate not as a single cluster but as clusters different from each other even if the shortest distance between the first cluster candidate and the second cluster candidate is equal to or less than a certain value. In this case, there is a high possibility that one cluster candidate includes noise, and thus, the measurement accuracy is increased by determining that the clusters are different from each other despite the proximity. Further, even in a case where a third cluster candidate (for example, a cluster candidate A3 illustrated in FIG. 9A) is present at a distance equal to or less than the certain value from a position at which the shortest distance between the first cluster candidate (for example, the cluster candidate A1 illustrated in FIG. 9A) and the second cluster candidate (for example, the cluster candidate A2 illustrated in FIG. 9A) is equal to or less than a certain value, the peak detection unit 241 determines that the third cluster candidate is a cluster different from both the first cluster candidate and the second cluster candidate.

When the peak detection unit 241 divides a plurality of peak candidate positions in the example illustrated in FIG. 9A into clusters according to the above procedure, the plurality of peak candidate positions in the example illustrated in FIG. 9A are divided into clusters CL1 to CL15 as illustrated in FIG. 9B.

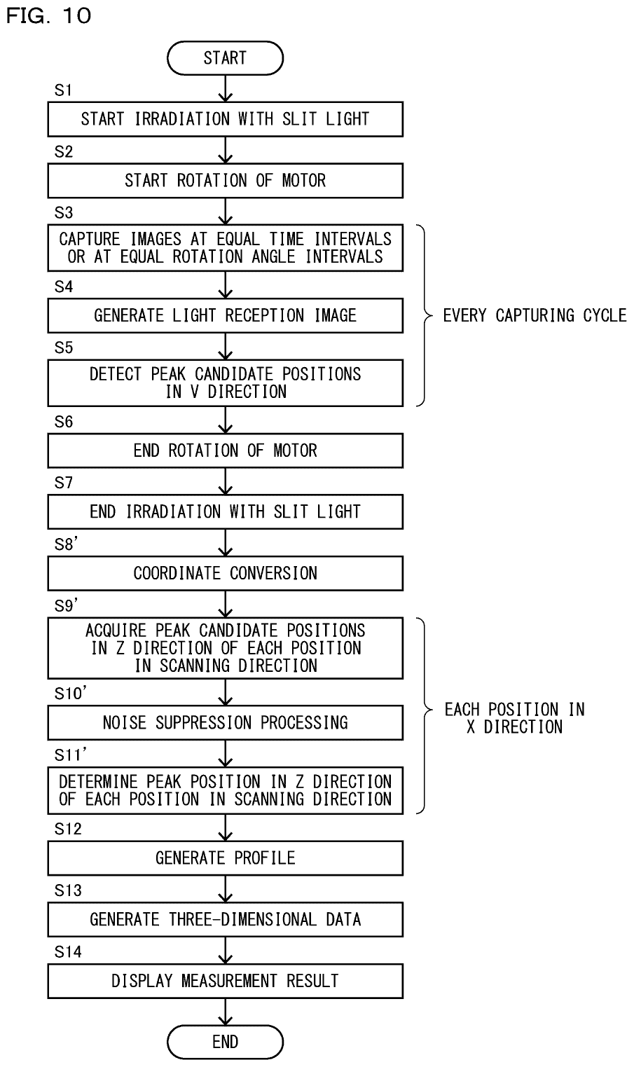

Here, in a case where a change in an inclination (the inclination with respect to the θ direction in the case of the flow processing illustrated in FIG. 8, and an inclination with respect to a Y direction in the case of flow processing illustrated in FIG. 10 to be described later) of a certain degree or more occurs in a cluster candidate even when a distance between a peak position candidate of any one light reception image and a peak position candidate of another light reception image is equal to or less than a certain value, the peak detection unit 241 may determine that clusters are different from each other with a location where the change in the inclination occurs as a boundary.

For example, a distance between a right end of peak candidate positions included in CL1 and a left end of peak candidate positions included in CL3 is equal to or less than a certain value, and thus, CL1 and CL3 can be regarded as one cluster, but are regarded as different clusters with a location where a change in an inclination occurs as a boundary since the change in the inclination of a certain degree or more occurs between CL1 and CL3 in this case. Noise is likely to occur in a location having a step in the scan direction, that is, the Y direction, such as an edge portion of the workpiece W. For this reason, a peak candidate position due to the true height of the workpiece W and a peak candidate position due to the noise are present together in one cluster if being collected into the same cluster despite a large change in the inclination, which leads to a decrease in measurement accuracy. When the location where the change in the inclination occurs is used as the boundary for discriminating between clusters as described above, it is possible to prevent the peak candidate position due to the true height of the workpiece W and the peak candidate position due to the noise from being present together in one cluster.

Next, the peak detection unit 241 calculates the number of peak candidate positions (hereinafter, referred to as the number of members) constituting each cluster, and deletes a cluster of which the number of members is equal to or less than a threshold. Noise can be suppressed by deleting a cluster having a small number of members since there is a tendency that the number of members of an unstable cluster caused by the noise decreases. For example, in a case where the threshold is set to two, the clusters CL6 to CL13 are deleted, and two-dimensional data of the peak candidate group divided into clusters illustrated in FIG. 9B is corrected to two-dimensional data of the peak candidate group divided into clusters illustrated in FIG. 9C.

Next, the peak detection unit 241 determines the entire cluster in which an absolute value of the inclination with respect to the 0 direction is equal to or more than a predetermined value as noise and removes the noise. As a result, the two-dimensional data of the peak candidate group divided into clusters illustrated in FIG. 9C is corrected by removing the clusters CL2, CL5, and CL14 to obtain two-dimensional data of the peak candidate group divided into clusters illustrated in FIG. 9D.

Further, in a case where a plurality of clusters are present in an arbitrary range in the 0 direction, the peak detection unit 241 generates profile data by preferentially using a cluster having a smaller absolute value of the inclination with respect to the θ direction among the plurality of clusters. Specifically, when a plurality of clusters are present in an arbitrary range in the e direction, a cluster having a larger absolute value of the inclination with respect to the 0 direction among the plurality of clusters is determined as noise and removed, and profile data is generated based on a cluster having a smaller absolute value of the inclination. Since a cluster having a larger absolute value of the inclination with respect to the θ direction is more likely to be a cluster caused by stray light, it is possible the possibility that noise can be suppressed by determining and removing the cluster having the larger absolute value of the inclination with respect to the θ direction as the noise.

In addition, in a case where a plurality of clusters partially overlap in an arbitrary range in the θ direction, the peak detection unit 241 generates profile data based on a cluster having a smaller absolute value of the inclination with respect to the θ direction among the plurality of clusters at an overlapping position, and generates profile data based on each of the plurality of clusters at positions other than the overlapping position. Since a peak candidate position due to the true height of the workpiece W and a peak candidate position due to noise are sometimes present together in one cluster, it is possible to reduce the possibility that a peak candidate position is excessively deleted by limiting the removal to only the overlapping position of the plurality of clusters in the θ direction.

For example, in a case where there are a cluster CLN-1 and a cluster CLN whose absolute value of the inclination with respect to the θ direction is larger than that of the cluster CLN-1 and smaller than a predetermined value, both the cluster CLN-1 and the cluster CLN are not removed if the cluster CLN-1 and the cluster CLN do not overlap in the θ direction as illustrated in FIG. 9E. On the other hand, as illustrated in FIG. 9F or 9G, if the cluster CLN-1 and the cluster CLN overlap in the θ direction, the cluster CLN is removed only at an overlapping position in the θ direction.

Note that two clusters having close inclinations (two clusters having an inclination difference equal to or less than an allowable value) are determined to be two clusters having the same inclination, and the peak detection unit 241 does not perform processing of determining and removing a cluster having a larger absolute value of the inclination with respect to the 0 direction as noise with respect to the two clusters determined to have the same inclination.

Finally, in a case where a plurality of peak candidate positions remain at each position in the θ direction, the peak detection unit 241 narrows down the peak candidate positions to one at each position in the θ direction using light amount information.

In step S10, the peak detection unit 241 sets a peak candidate position at each position in the θ direction left by the noise suppression processing in step S9 as a peak position at each position in the θ direction. When the process of step S10 ends, the flow proceeds to step S11.

The profile generation unit 242 converts a profile in the UV coordinate system into that in the XYZ coordinate system (step S11), and generates a two-dimensional profile of the XZ cross-section of the workpiece W (step S12).

In subsequent step S13, the three-dimensional data generation unit 243 generates three-dimensional data.

In subsequent step S14, the display device 3 displays a measurement result. The measurement result is, for example, a cross-sectional view of the workpiece W based on the profile, a three-dimensional image of the workpiece W based on three-dimensional data, or the like. When the process of step S14 ends, the processing flow of FIG. 8 ends.

In the processing flow of FIG. 8, the coordinate conversion of step S11 is executed after the noise suppression processing of step S8 is executed. However, as in the processing flow of FIG. 10, the coordinate conversion may be executed first, and then the noise suppression processing may be executed.

Step S8′ in FIG. 10 corresponds to step S11 in FIG. 8, step S9′ in FIG. 10 corresponds to step S8 in FIG. 8, step S10′ in FIG. 10 corresponds to step S9 in FIG. 8, and step S11′ in FIG. 10 corresponds to step S10 in FIG. 8.

The U direction in steps S8 to S10 in FIG. 8 is replaced with the X direction in steps S9′ to S11′ in FIG. 10, and the V direction in steps S8 to S10 in FIG. 8 is replaced with the Z direction in steps S9′ to S11′ in FIG. 10.

### Second Embodiment

### <Optical Displacement Measurement System>

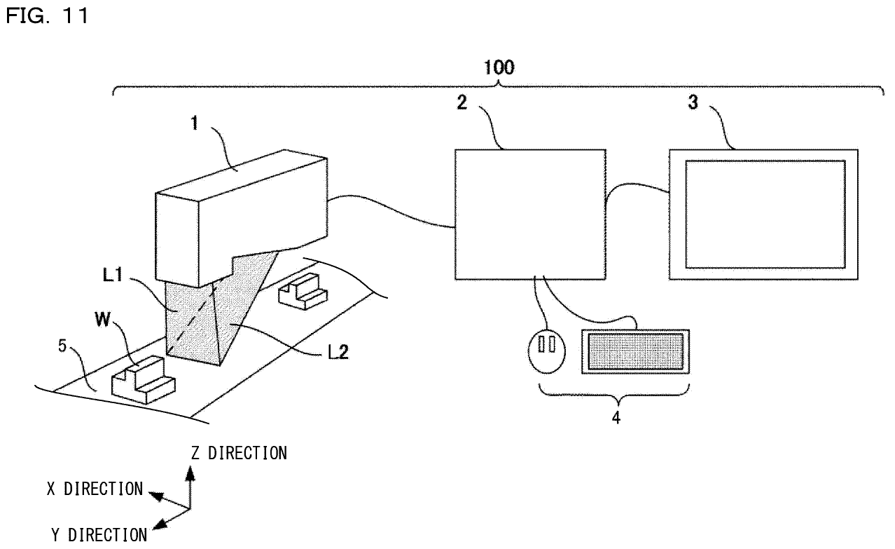

FIG. 11 is a diagram illustrating a schematic configuration example of an optical displacement measurement system according to a second embodiment. An optical displacement measurement system 100 illustrated in FIG. 11 includes an optical displacement meter 1, a control device 2, a display device 3, an input device 4, and a belt conveyor 5.

In the present embodiment, an X direction corresponds to a width direction of slit light L1 output from the optical displacement meter 1, a Z direction corresponds to a height direction of a workpiece W, and a Y direction is a direction orthogonal to the X direction and the Z direction. A XZ plane to be described later is a plane extending in the X direction and the Z direction.

The optical displacement measurement system 100 is a system that measures a profile and a three-dimensional shape of the workpiece W conveyed in the Y direction by the belt conveyor 5. The profile of the workpiece W is data indicating an outer edge of a cut surface of the workpiece W by the slit light L1. When the slit light is emitted in parallel to the XZ plane, the profile of the workpiece W is data indicating an outer edge of a cut surface parallel to the XZ plane, and thus, is also referred to as a two-dimensional profile of a XZ cross-section of the workpiece W.

For example, the profile is an aggregate of (xi, zi) (i is an index). “xi” indicates a position in the X direction. “zi” indicates a height in the Z direction. Note that the three-dimensional shape is an aggregate of (xi, yi, zi). “yi” indicates a position in the Y direction.

The optical displacement meter 1 operates in accordance with an instruction from the control device 2. The optical displacement meter 1 outputs the slit light L1 extending in the X direction and receives reflected light L2 from the workpiece W. Then, the optical displacement meter 1 calculates a profile of the workpiece W based on a light reception result. The optical displacement meter 1 captures images at regular intervals to generate profiles of the workpiece W having different values of yi. In addition, the optical displacement meter 1 generates three-dimensional shape data of the workpiece W from the profiles of the workpiece W having different values of yi.

The control device 2 outputs an instruction based on a user input received by the input device 4 to the optical displacement meter 1, and receives a measurement result of the workpiece W from the optical displacement meter 1. In addition, the control device 2 outputs a display signal to the display device 3. The control device 2 is, for example, a personal computer, a programmable logic control unit, or the like.

The display device 3 displays, for example, the measurement result of the workpiece W, a user interface (UI) for setting the optical displacement meter 1, and the like based on the display signal from the control device 2.

The input device 4 receives the user input with respect to the optical displacement measurement system 100. In FIG. 1, a keyboard and a mouse are illustrated as the input device 4. However, the input device 4 is not limited to the keyboard and the mouse. For example, the input device 4 may be a touch panel disposed on a display screen of the display device 3.

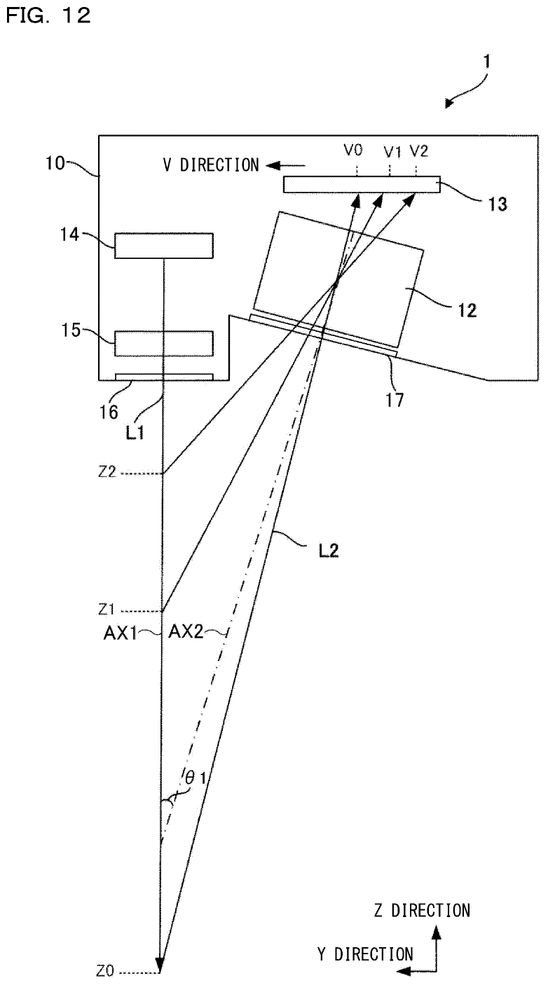

FIG. 12 is a view illustrating the principle of a light sectioning method (triangulation). A light projecting unit 11, a light receiving lens 12, and a imaging unit 13 are built in a housing 10 of the optical displacement meter 1. The light projecting unit 11 includes a light source 14 and a light projecting lens 15. For example, the light source 14 may be a laser light emitter, and the light projecting lens 15 may include a plurality of lenses including a cylindrical lens. Light output from the light source 14 passes through the light projecting lens 15 and is converted into the slit light L1. The housing 10 is provided with a light projecting window 16 through which the slit light L1 passes. Similarly, the housing 10 is provided with a light receiving window 17 for guiding the reflected light L2 to the inside of the housing 10.

The light receiving lens 12 is a lens for forming an image of the reflected light L2 on the imaging unit 13. The imaging unit 13 is a sensor having a plurality of pixels (which may be referred to as light receiving elements or photoelectric conversion elements) arranged two-dimensionally. As illustrated in FIG. 12, a light reception axis AX2 of the imaging unit 13 is inclined by an angle θ1 with respect to a light projection axis AX1 of the light source 14. That is, the reflected light L2 from a height Z0 forms an image at a position V0 in the V direction of the imaging unit 13. The reflected light L2 from a height Z1 forms an image at a position V1 in the V direction of the imaging unit 13. The reflected light L2 from a height Z2 forms an image at a position V2 in the V direction of the imaging unit 13. In this manner, the V direction of the imaging unit 13 corresponds to the Z direction of the workpiece W. Although a U direction of the imaging unit 13 is not illustrated, the U direction corresponds to the X direction of the workpiece W. That is, a vertical direction of an image, which is a light reception result output by the imaging unit 13, is the V direction, and a horizontal direction thereof is the U direction.

Although the light source 14 is disposed such that the slit light L1 is output in a Z direction in FIG. 12, a positional relationship between a pair of the light source 14 and the light projecting lens 15 and a pair of the imaging unit 13 and the light receiving lens 12 may be reversed.

### <Position (Calculation of Height)>

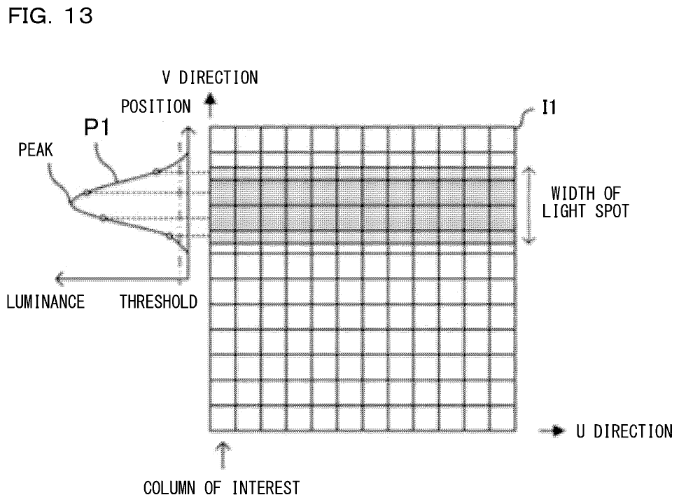

FIG. 13 is a view for describing a method of calculating a height forming a profile from an image I1 that is a light reception result output by the imaging unit 13. The slit light L1 has a certain width in the Y direction. Therefore, a width of a light spot formed by the reflected light L2 on the light receiving surface of the imaging unit 13 is also a width that spans the plurality of photoelectric conversion elements.

Therefore, the optical displacement meter 1 obtains an approximate curve P1 indicating a change in a luminance value from luminance values of pixels, and calculates a position in the V direction at which a peak value is obtained in the approximate curve P1. In FIG. 13, the leftmost column is a column of interest, and the distribution (approximate curve P1) of luminance values of the column of interest is illustrated. The approximate curve P1 is obtained by curve fitting or the like of a plurality of sample values. A sample value below a detection threshold is not considered. The position in the V direction at which the peak value is obtained indicates a height of the workpiece W. The optical displacement meter 1 obtains the approximate curve P1 at each position (each pixel column) in the U direction, and calculates the position (height) in the V direction at which the peak value is obtained from the approximate curve P1. This calculation processing is executed at each position in the U direction, thereby obtaining one profile. Such calculation processing may be referred to as subpixel processing.

Note that, for example, a coordinate conversion condition (for example, a coordinate conversion table) indicating a correspondence relationship among UV coordinates, a relative position y between the optical displacement meter 1 and the workpiece W in the Y direction, and local coordinates (X, Y, Z) and expressed by (U, V, θ)=(X, Y, Z) is generated by calibration before shipment, and is stored in a storage unit (not illustrated) of the optical displacement meter 1, and thus, the optical displacement meter 1 can convert a profile in a UV coordinate system into a profile in an XYZ coordinate system based on the relative position y between the optical displacement meter 1 and the workpiece W in the Y direction by simple calculation. Note that, in the coordinate conversion, equal interval correction in the X direction and the Y direction may be executed such that positions in the X direction and the Y direction are plotted at equal intervals, and a Z coordinate corresponding to the corrected (X, Y) may be obtained by linear interpolation or the like and output as a measurement result. Image processing to be performed on the measurement result is often based on data sampled at equal intervals in the X direction and the Y direction, and thus the subsequent image processing is facilitated by the equal interval correction.

### <Functional Blocks>

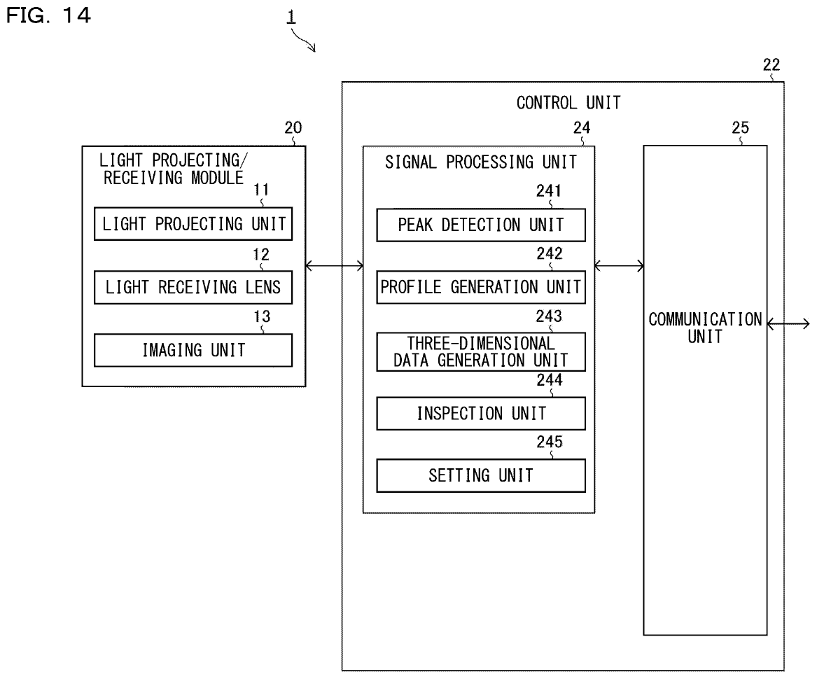

FIG. 14 is a functional block diagram of the optical displacement meter 1. The optical displacement meter 1 includes a light projecting/receiving module 20 and a control unit 22.

The light projecting/receiving module 20 holds the light projecting unit 11, the light receiving lens 12, and the imaging unit 13 in an integrated manner.

The control unit 22 includes a signal processing unit 24 and a communication unit 25. The signal processing unit 24 controls the light projecting unit 11 to emit the slit light L1 from the light projecting unit 11.

The signal processing unit 24 includes a peak detection unit 241, a profile generation unit 242, a three-dimensional data generation unit 243, an inspection unit 244, and a setting unit 245.

The peak detection unit 241 detects positions (peak positions) in the V direction having peaks of luminance values based on light reception results output from the imaging unit 13. The profile generation unit 242 generates one piece of profile data by collecting heights (zi) of the workpieces W at the respective positions (xi) in the X direction obtained by the peak detection unit 241. The three-dimensional data generation unit 243 generates three-dimensional shape data of the workpiece W from profiles of the workpieces W having different values of yi and generated by the profile generation unit 242.

The inspection unit 244 inspects the workpiece W based on the three-dimensional shape data of the workpiece W generated by the three-dimensional data generation unit 243. The inspection unit 244 performs predetermined measurement on the three-dimensional shape data of the workpiece W, and inspects the workpiece W based on a result of the measurement. For example, the inspection unit 244 measures a length, an angle, and the like of a predetermined portion of the workpiece W. Then, the inspection unit 244 determines whether the workpiece W is a non-defective product based on these measurement results, preset thresholds, and the like.

When the input device 4 illustrated in FIG. 11 is operated by the user, the setting unit 245 is a portion that detects the operation and receives various settings and the like related to the control unit 22. For example, the setting unit 245 sets an inspection parameter to be used by the inspection unit 244. In addition, for example, the setting unit 245 sets an imaging parameter that is an imaging condition in the imaging unit 13.

Note that at least some of the peak detection unit 241, the profile generation unit 242, the three-dimensional data generation unit 243, the inspection unit 244, and the setting unit 245 may be provided at a place separated from a main body of the optical displacement meter 1 (for example, inside the control device 2 illustrated in FIG. 11). In this case, the optical displacement meter 1 has a separate structure including the main body of the optical displacement meter 1 and a separate portion of the optical displacement meter 1.

The communication unit 25 performs wired or wireless communication with the control device 2. For example, the communication unit 25 receives an instruction from the control device 2 and transmits the instruction to the control unit 22. In addition, the communication unit 25 transmits, for example, the profile data and the three-dimensional shape data of the workpiece W generated by the signal processing unit 24 and an inspection result of the workpiece W determined by the inspection unit 244 to the control device 2.

### <Countermeasure Against Stray Light>

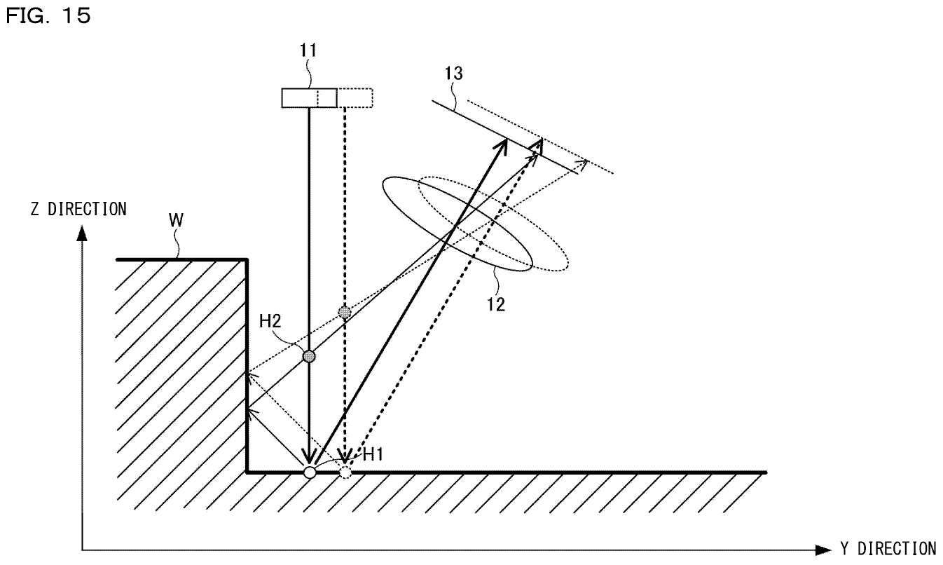

FIG. 15 is a schematic view illustrating a true height of the workpiece W and a height that may be erroneously recognized. In FIG. 15, the light projecting unit 11, the light receiving lens 12, and the imaging unit 13 at a first measurement timing are illustrated by solid lines, and the light projecting unit 11, the light receiving lens 12, and the imaging unit 13 at a second measurement timing are illustrated by broken lines.

A true height H1 of the workpiece W hardly changes between the first measurement timing and the second measurement timing, whereas a height H2 at which the workpiece W may be erroneously recognized due to light (stray light) multiple-reflected on the surface of the workpiece W and entering the imaging unit 13 greatly changes between the first measurement timing and the second measurement timing.

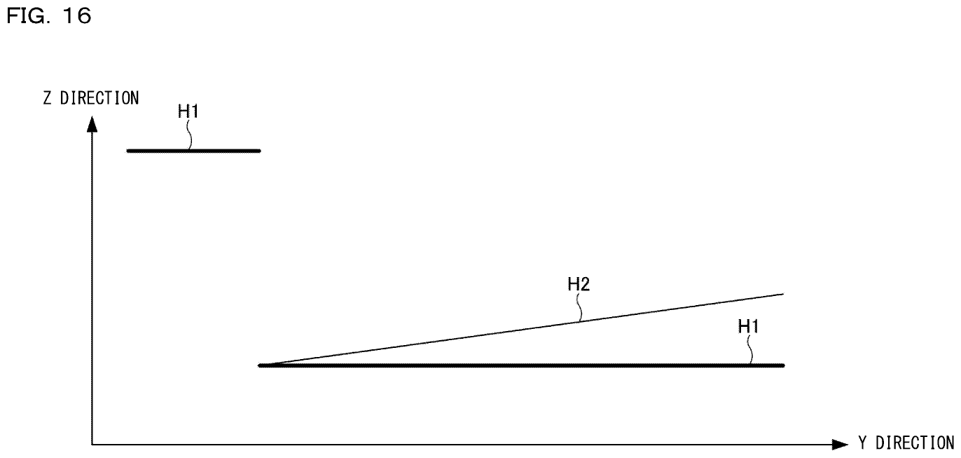

Therefore, in a case where the peak detection unit 241 does not execute a countermeasure against the stray light and the workpiece W having the shape illustrated in FIG. 15 is measured, profile data obtained by collecting heights (zi) of the workpieces W at the respective positions (yi) in the Y direction at a certain position in the X direction is as illustrated in FIG. 16. As can be seen from FIG. 16, an inclination with respect to the Y direction of the height H2 at which the workpiece W may be erroneously recognized due to the light (stray light) multiple-reflected on the surface of the workpiece W and entering the imaging unit 13 is larger than an inclination with respect to the Y direction of the true height H1 of the workpiece W. In the present embodiment, the peak detection unit 241 executes the countermeasure against the stray light using the knowledge found by the present inventor.

### <Processing Flow>

The motor 21 of the first embodiment is replaced with a motor for driving the belt conveyor 5 in the present embodiment, and a scanning direction is a direction (Y direction) in which the workpiece W is conveyed by the belt conveyor 5 in the present embodiment, instead of a rotation direction of the light projecting/receiving module 20 in the first embodiment. Therefore, the processing flow illustrated in FIG. 8 and the processing flow illustrated in FIG. 10 can also be applied to the present embodiment by changing the motor and changing the contents of coordinate conversion.

### Modified Example of Relative Movement

In the optical displacement measurement system 100 illustrated in FIG. 11, a profile and a three-dimensional shape of the workpiece W are measured as the workpiece W is moved in the Y direction relative to the light projecting/receiving module 20 of the optical displacement meter 1 by the belt conveyor 5. Although the workpiece W moves in the present embodiment, the relative movement between the workpiece W and the light projecting/receiving module 20 of the optical displacement meter 1 is not limited thereto. Therefore, the light projecting/receiving module 20 of the optical displacement meter 1 may be moved without moving the workpiece W, or both the workpiece W and the light projecting/receiving module 20 of the optical displacement meter 1 may be moved.

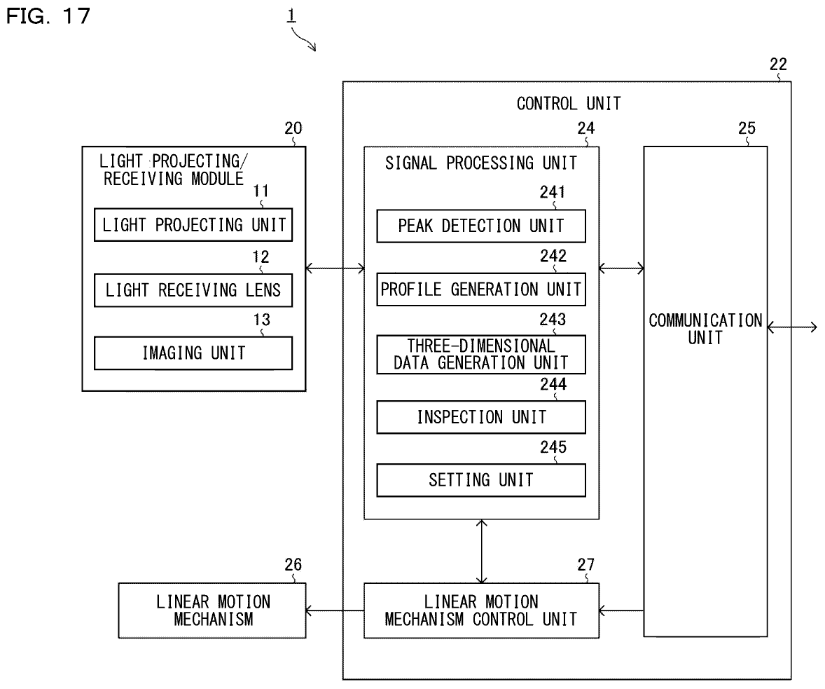

In a case where the light projecting/receiving module 20 of the optical displacement meter 1 is moved, as illustrated in FIG. 17, the optical displacement meter 1 includes a linear motion mechanism 26, and the control unit 22 includes a linear motion mechanism control unit 27. The linear motion mechanism control unit 27 controls the linear motion mechanism 26 to move the light projecting/receiving module in the Y direction in the housing 10.

### <<Others>>

Note that, in addition to the above-described embodiments, various alterations can be applied to various technical features disclosed in the present specification within a scope not departing from the spirit of the technical creation. That is, it should be considered that the above-described embodiments are illustrative in all respects and not restrictive. In addition, the technical scope of the present invention is defined by the claims, and should be understood to include all modifications falling within the meaning and scope equivalent to the claims.

What is claimed is:

1. An optical displacement meter comprising:
a light projection unit that irradiates a workpiece performing a relative movement in a direction intersecting an X direction with slit light extending in the X direction;
an image sensor that includes a plurality of pixels, receives reflected light reflected from the workpiece by the plurality of pixels, and outputs a light reception image indicating a light receiving amount distribution, the plurality of pixels being two-dimensionally arranged in a U direction corresponding to the X direction and a V direction orthogonal to the U direction; and
a control unit that generates profile data of the workpiece based on the light reception image and measures a shape of the workpiece based on the profile data,
wherein the control unit
controls the image sensor to sequentially acquire a plurality of the light reception images along with the relative movement,
detects a peak position candidate in the V direction for each of positions in the U direction based on the light receiving amount distribution of the light reception image for each of the light reception images,
for each of the positions in the U direction,
generates one or more clusters including a plurality of peak position candidates selected in such a manner that a distance between a peak position candidate of any one of the light reception images and a peak position candidate of another one of the light reception images is equal to or less than a certain value,
determines whether noise is included in the cluster based on an inclination of the cluster with respect to a direction of the relative movement, and
generates the profile data based on a result of the determination.

2. An optical displacement meter comprising:
a light projection unit that irradiates a workpiece performing a relative movement in a direction intersecting an X direction with slit light extending in the X direction;
an image sensor that includes a plurality of pixels, receives reflected light reflected from the workpiece by the plurality of pixels, and outputs a light reception image indicating a light receiving amount distribution, the plurality of pixels being two-dimensionally arranged in a U direction corresponding to the X direction and a V direction orthogonal to the U direction; and
a control unit that generates profile data of the workpiece based on the light reception image and measures a shape of the workpiece based on the profile data,
wherein the control unit
controls the image sensor to sequentially acquire a plurality of the light reception images along with the relative movement,
detects a peak position candidate in the V direction for each of positions in the U direction based on the light receiving amount distribution of the light reception image for each of the light reception images,
converts UV coordinate information including each of the positions in the U direction and the peak position candidate in the V direction at each of the positions in the U direction and information regarding the relative movement into XYZ coordinate information including a peak position candidates in a Z direction corresponding to each of XY coordinates based on a predetermined coordinate conversion condition,
for each position in the X direction of the XYZ coordinate information,
generates one or more clusters including a plurality of peak position candidates selected in such a manner that a distance between a peak position candidate at any one position in the Y direction and a peak position candidate at another position in the Y direction is equal to or less than a certain value,
determines whether noise is included in the cluster based on an inclination of the cluster with respect to the Y direction, and
generates the profile data based on a result of the determination.

3. The optical displacement meter according to claim 1, wherein in a case where a first cluster candidate and a second cluster candidate having mutually different inclinations are present in an arbitrary range in the direction of the relative movement, the control unit determines the first cluster candidate and the second cluster candidate not as a single cluster but as clusters different from each other even if a shortest distance between the first cluster candidate and the second cluster candidate is equal to or less than the certain value.

4. The optical displacement meter according to claim 3, wherein the control unit determines that a third cluster candidate is a cluster different from both the first cluster candidate and the second cluster candidate in a case where the third cluster candidate is present at a distance equal to or less than the certain value from a position where the shortest distance between the first cluster candidate and the second cluster candidate is equal to or less than the certain value.

5. The optical displacement meter according to claim 1, wherein in a case where a change in an inclination of a certain degree or more occurs in a cluster candidate even if a distance between a peak position candidate of any one of the light reception images and a peak position candidate of another one of the light reception images is equal to or less than the certain value, the control unit determines that clusters are different from each other with a location where the change in the inclination occurs as a boundary.

6. The optical displacement meter according to claim 1, wherein the control unit determines and removes an entire cluster in which an absolute value of the inclination is a predetermined value or more as noise.

7. The optical displacement meter according to claim 1, wherein in a case where a plurality of the clusters are present in an arbitrary range in the direction of the relative movement, the control unit generates the profile data by preferentially using a cluster having a smaller absolute value of the inclination among the plurality of clusters.

8. The optical displacement meter according to claim 1, wherein in a case where a plurality of the clusters are present in an arbitrary range in the direction of the relative movement, the control unit determines and removes a cluster having a larger absolute value of the inclination among the plurality of clusters and generates the profile data based on a cluster having a smaller absolute value of the inclination.

9. The optical displacement meter according to claim 1, wherein in a case where a plurality of the clusters partially overlap in an arbitrary range in the direction of the relative movement, the control unit generates the profile data based on a cluster having a smaller absolute value of the inclination among the plurality of clusters at an overlapping position, and generates the profile data based on each of the plurality of clusters at positions other than the overlapping position.

10. The optical displacement meter according to claim 2, wherein in a case where a first cluster candidate and a second cluster candidate having mutually different inclinations are present in an arbitrary range in the direction of the relative movement, the control unit determines the first cluster candidate and the second cluster candidate not as a single cluster but as clusters different from each other even if a shortest distance between the first cluster candidate and the second cluster candidate is equal to or less than the certain value.

11. The optical displacement meter according to claim 10, wherein the control unit determines that a third cluster candidate is a cluster different from both the first cluster candidate and the second cluster candidate in a case where the third cluster candidate is present at a distance equal to or less than the certain value from a position where the shortest distance between the first cluster candidate and the second cluster candidate is equal to or less than the certain value.

12. The optical displacement meter according to claim 2, wherein in a case where a change in an inclination of a certain degree or more occurs in a cluster candidate even if a distance between a peak position candidate of any one of the light reception images and a peak position candidate of another one of the light reception images is equal to or less than the certain value, the control unit determines that clusters are different from each other with a location where the change in the inclination occurs as a boundary.

13. The optical displacement meter according to claim 2, wherein the control unit determines and removes an entire cluster in which an absolute value of the inclination is a predetermined value or more as noise.

14. The optical displacement meter according to claim 2, wherein in a case where a plurality of the clusters are present in an arbitrary range in the direction of the relative movement, the control unit generates the profile data by preferentially using a cluster having a smaller absolute value of the inclination among the plurality of clusters.

15. The optical displacement meter according to claim 2, wherein in a case where a plurality of the clusters are present in an arbitrary range in the direction of the relative movement, the control unit determines and removes a cluster having a larger absolute value of the inclination among the plurality of clusters and generates the profile data based on a cluster having a smaller absolute value of the inclination.

16. The optical displacement meter according to claim 2, wherein in a case where a plurality of the clusters partially overlap in an arbitrary range in the direction of the relative movement, the control unit generates the profile data based on a cluster having a smaller absolute value of the inclination among the plurality of clusters at an overlapping position, and generates the profile data based on each of the plurality of clusters at positions other than the overlapping position.
